(19) United States
(12) Patent Application Publication
(10) Pub. No.: US 2005/0245142 A1
(43) Pub. Date: Nov. 3, 2005

(54) Sheet metal coil spring testing connector

(76) Inventor: January Kister, Portola Valley, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/838,873

(22) Filed: May 3, 2004

(51) Int. Cl. H01R 4/48

(52) U.S. Cl. 439/817

(57) ABSTRACT

Sheet metal radially and axially coiled around a coiling axis forms a resilient band spring with a base arc for interlocking with a base plate and a contacting tip for contacting with test contacts. The spring band coils in a fashion such that at least two adjacent coils overlap in axial direction radially supporting and conductively contacting each other at least in operationally deflected condition of the connector. A number of connectors may be held via their base arcs in correspondingly shaped fits of a base plate. The connectors may have one or two opposing tips and being either conductively connected with their base arc to a PCB or held in through holes thereby operating as interconnectors. The contacting tip may be centered, off centered or circumferentially and multiplicatively positioned for zero, radial or circumferential scrubbing action. Two or more independent connectors may be intertwined around a single coiling axis.

### FIELD OF INVENTION

The present invention relates to testing connectors. In particular, the present invention relates testing connectors of coiled sheet metal like material.

### BACKGROUND OF INVENTION

In the field of electronic circuitry testing, test contact size and array pitch ever decrease. At the same time test signal voltages drop and test signal frequencies increase. Hence there exists a continuous need for testing connectors with improved electrical properties in the conductive path along the testing connector and structural properties including maximum deflection, lateral stiffness, inexpensive fabrication, simple assembly with tight pitch and tunable scrubbing within a minimal footprint. The present invention addresses these needs.

### SUMMARY

A connector is fabricated from sheet metal like material radially and axially coiled around a coiling axis such that a resilient coil spring band is formed between a radially resilient base arc for interlocking with a base plate and a contacting tip for temporarily contacting test contacts. The spring band extends and coils from the base arcs in a fashion such that at least two adjacent coils overlap in axial direction with respect to the coiling axis and radially support each other at least in operationally deflected condition. The radial support of adjacent coils provides for a conductive shortcut path across the coils from the contacting tip to the base arc. A number of connectors may be tightly arrayed and held via their base arcs in correspondingly shaped fits of a base plate.

The connectors may have spring bands extending from the base arc in opposite direction forming interconnects that provide a direct conductive connection between opposing peripheral contacting tips at the opposing peripheral ends of the spring bands. The base fits may be through holes with recess features receiving interlocking structures radially extending from the base arc. The connector may also be conductively connected to a conductive lead of a base plate in an exemplary configuration of a printed circuit board.

The contacting tip may be centered, off centered or circumferentially and multiplicatively positioned with respect to the coiling axis, which provides for zero, radial or circumferential scrubbing action on the test contact. Two or more independent connectors may be intertwined around the coiling axis.

The sheet metal coil spring connector provides a minimal conductive path and at the same time a relatively large deflection for a given building height in direction of the coiling axis. In addition, the overlapping spring band coils increase lateral stability opposing off axis forces induced on the contacting tip from scrubbing action. Dependent on the connector's scale, various well known fabrication techniques may be employed including electroplating for shaping the sheet metal contours and differentiated opposite surface treatment techniques for inducing a controlled coiling of the sheet metal.

### BRIEF DESCRIPTION OF THE FIGURES

FIG. 1 is a first perspective view of an exemplary interconnect array including sheet metal coil spring connectors in an exemplary configuration with two opposing spring bands, centered contacting tips and clasping interlocking structures.

FIG. 2 is a top view of a sheet metal coil spring connector of FIG. 1.

FIG. 3A is a cross section of the sheet metal coil spring connector as indicated in FIG. 2 by section line A-A.

FIG. 3B is a second perspective view of a sheet metal coil spring connector of FIG. 1.

FIG. 4 is a top view of an exemplary sheet metal coil spring connector with off center contacting tip and central interlocking structures.

FIG. 5 is the second perspective view of the sheet metal coil spring connector of FIG. 4.

FIG. 6 is a third perspective view of the sheet metal coil spring connector of FIG. 1 in flattened condition during an intermediate fabrication step.

FIG. 7 is a third perspective view of the sheet metal coil spring connector of FIG. 4 in flattened condition during an intermediate fabrication step.

FIG. 8 is the first perspective view of the sheet metal coil spring connector of FIG. 4 sandwiched with its central interlocking features in between sandwich plates. The sandwich plates are depicted in section view.

FIG. 9 is a fourth perspective view of an exemplary sheet metal coil spring connector composed of two intertwined sheet metal structures.

FIG. 10 is the second perspective view of an enlarged spring band end including a centered contacting tip of the sheet metal coil spring connector of FIG. 1.

FIG. 11 is the second perspective view of an enlarged spring band end including an off center contacting tip of the sheet metal coil spring connector of FIG. 4.

FIG. 12 is the second perspective view of an enlarged spring band end including multiple circumferentially arrayed contacting tips of the sheet metal coil spring connector of FIG. 8.

FIG. 13 is a front view of a spectral displacement plot of a spring band under an exemplary analysis condition and a contacting condition in accordance with the centered contacting tip of FIG. 10. Transparently superimposed in grey is the same spring band in non deformed condition.

FIG. 14 is a top view of the spectral displacement plot of FIG. 13 also with transparently superimposed non deformed grey spring band.

FIG. 15 is a front view of a spectral displacement plot of a spring band under the exemplary analysis condition of FIG. 13 and a contacting condition in accordance with the off centered contacting tip of FIG. 11. Transparently superimposed in grey is the same spring band in non deformed condition.

FIG. 16 is a top view of the spectral displacement plot of FIG. 15 also with transparently superimposed non deformed grey spring band.

FIG. 17 is a top view of a spectral displacement plot of a spring band under the exemplary analysis condition of FIGS. 13, 15 and a contacting condition in accordance with the multiple circumferential contacting tips of FIG. 12. Transparently superimposed in grey is the same spring band in non deformed condition.

### DETAILED DESCRIPTION

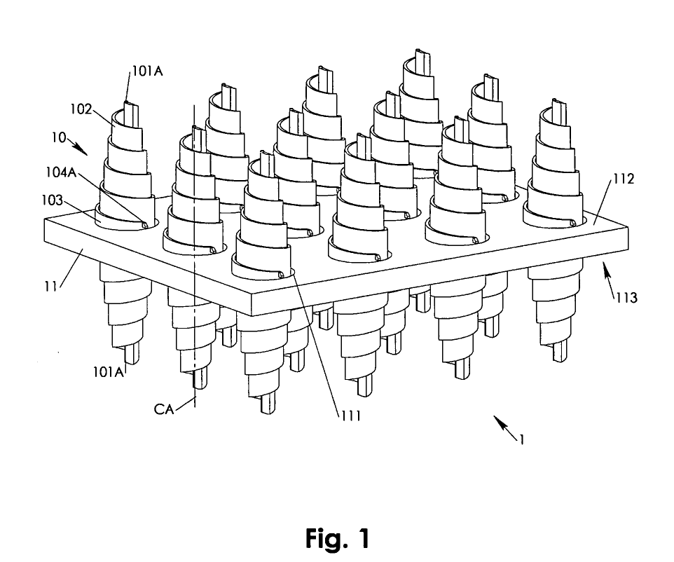

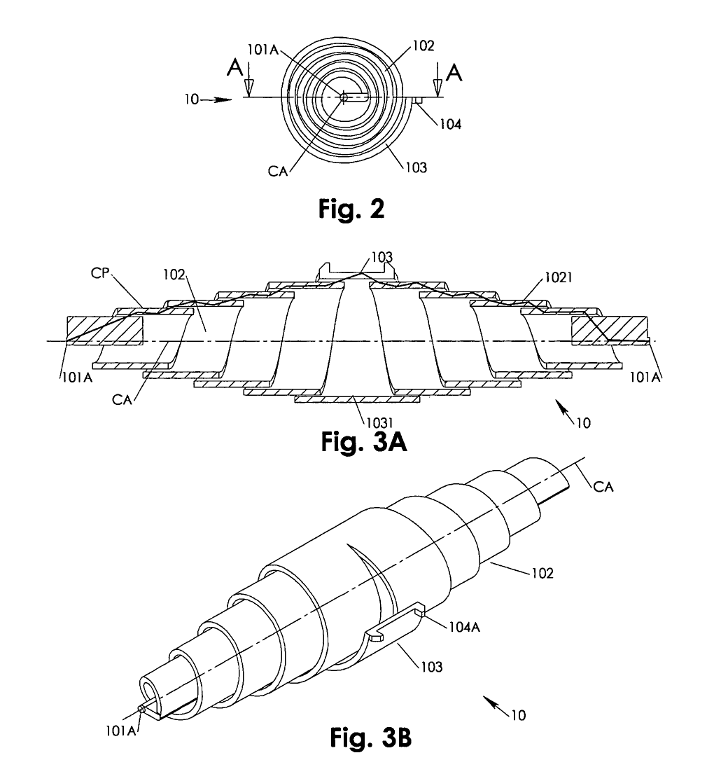

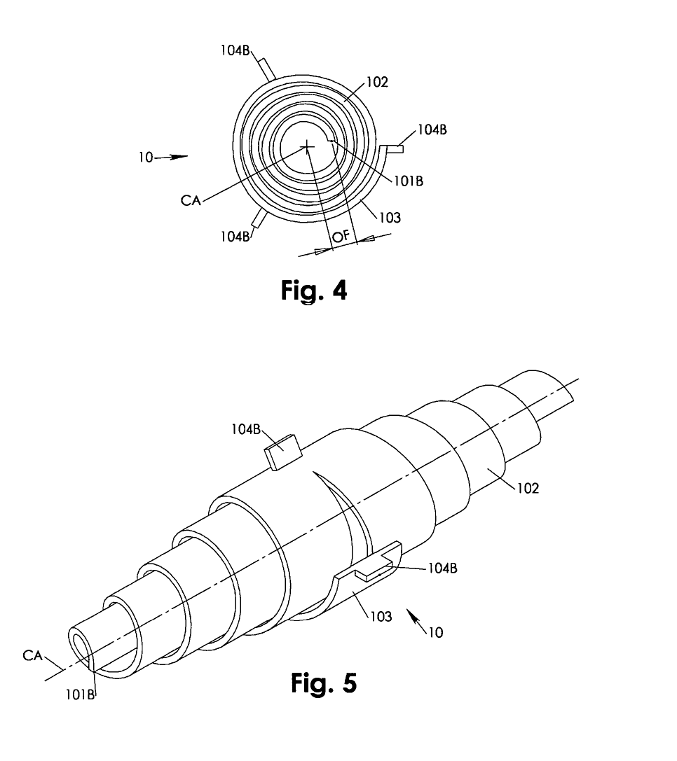

According to FIGS. 1-5, a sheet metal coil spring connector 10 may include a radially resilient base arc 103 preferably concentric to a coiling axis CA. The connector 10 may further include a spring band 102 extending from the base arc 103. The spring band 102 coils radially and axially with respect to the coiling axis CA such that at least two adjacent coils of the spring band 102 overlap in axial direction and radially support each other at least in operationally deflected condition. The operationally deflected condition may occur during operational contacting of the contacting tip(s) 101A, 101B, 101C (see FIG. 12) with a test contact within a probe apparatus as may be well appreciated by anyone skilled in the art.

As shown in FIG. 3A, the radial support may occur in conjunction with the contacting of adjacent overlapping coils, which may provide for a shortcutting conductive path CP across the individual coils and approximately in direction parallel to the coiling axis CA. Defining design elements of the connector 10 include a first lengthy cross section 1031 of the base arc 103 with its first long side being substantially parallel to the coiling axis CA and a second lengthy cross section 1021 of the spring band 102. The second lengthy cross section 1021 may have its second long side preferably parallel to the coiling axis CA.

In an alternate embodiment, the second long side may alternatively be in a positive angle with respect to the outward pointing coiling axis CA providing a circumferential conical interlocking of adjacent loops during operational deflection as may be well appreciated by anyone skilled in the art. The circumferential interlocking may assist in increasing the connector's 10 lateral stiffness and/or spring force and may also assist in reducing electrical resistance of the shortcutting conductive path CP.

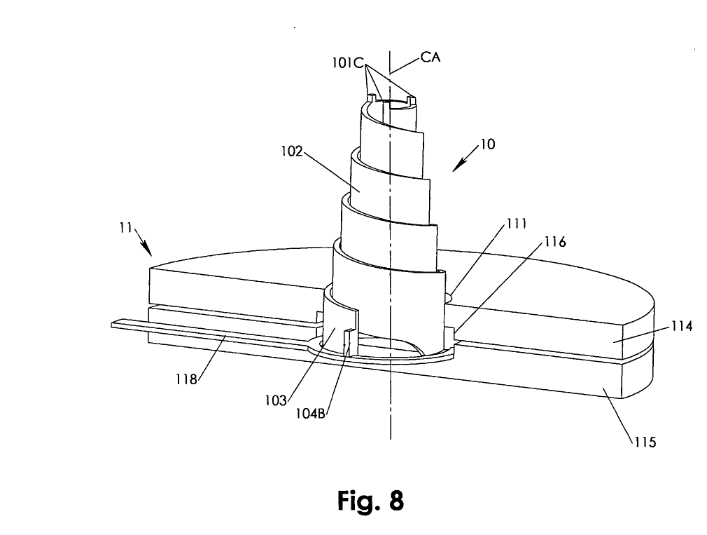

Interlocking structures 104A, 104B may radially protrude from the base arc 103. As shown in FIG. 1, clasping interlocking structures 104A may extend beyond the boundaries of a base plate fit 111 and clasp the base plate 11 on its top and bottom faces 112, 113. As shown in FIG. 8, central interlocking structures 104B may protrude centrally from the base arc 103 interlocking with a central recess feature 116 of the base plate 11.

Referring to FIG. 1, the connector 10 may be assembled in the base plate fit 111 by relying on the base arc's 103 radial resilience to reduce the clasping interlocking structure's 104A radial extension below the extension of the base plate fit 111 such that the base are 103 may be inserted into the base plate fit 111. This assembly method may be preferably utilized in combination with the clasping interlocking structures 104A. Referring to FIG. 8, the connector 10 may also be assembled by providing two sandwich plates 114, 115 separated across the recess feature 116 such that the connector 10 may be placed with its interlocking structure(s) 104B in the open recess feature 116. The connector 10 may align itself within the base plate fit 111 via a snuggle contact of the base arc 103 on the side walls of the base plate fit 111 and/or by circumferentially arraying at least three interlocking structures 104A, 104B such that the connector 10 is held on the base plate fit 111 in a spatially fully defined position and orientation with respect to the base plate 11.

The connector 10 may feature two representations of the spring band 102 extending from the base arc 103 in opposite direction substantially along the coiling axis CA. In that configuration, the connector 10 operates as a well known interconnector establishing conductive contact between two opposing contacts of which one may be the test contact and the other one a contact of the probe apparatus. As illustrated in FIG. 1, the base plate fit 111 may be configured as a through hole holding the connector 10 such that the two spring bands 102 extend from opposite top and bottom sides 112, 113 of the base plate 11.

Referring to FIG. 8, the connector 10 may also be conductively connected via its base arc 103 and/or via the interlocking structures 104A, 104B to a conductive lead 118. The conductive connection may be established by contact force and/or a soldered connection as may be well appreciated by anyone skilled in the art. One or both sandwich plates 114, 115 may be a well known printed circuit board (PCB).

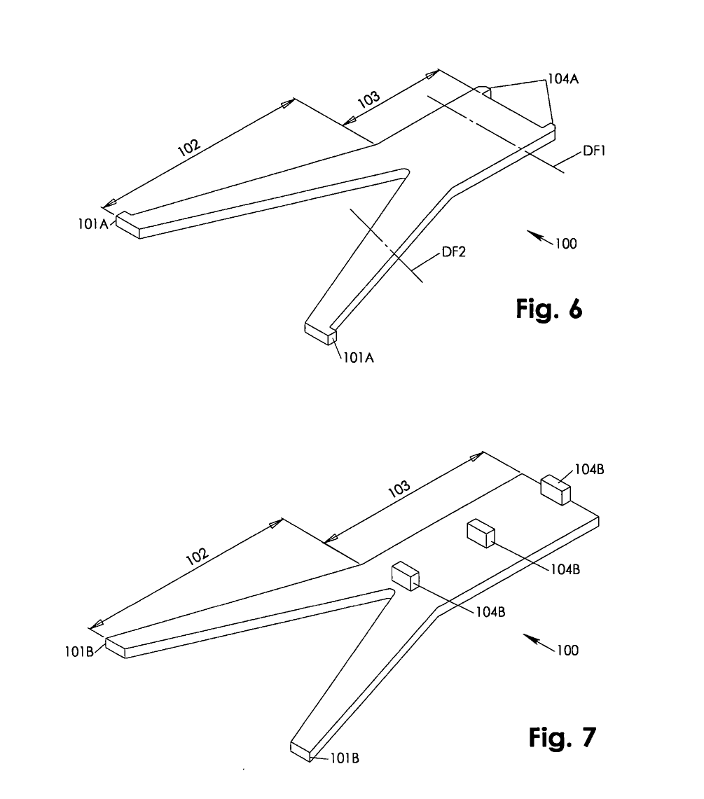

Referring to FIGS. 6, 7, the connector 10 may be fabricated in flat condition from flat sheet metal like material by sputtering, electroplating, etching, laser cutting, or stamping. The coiling of the base arc 103 may be accomplished by differentiated opposite surface treatment techniques for inducing a controlled coiling of the sheet metal along deformation fronts DF1 and/or DF2. In context with the present invention, differentiated opposite surface treatment includes metal deposition induced stresses, laser scribing, ion implantation, rolling or other heat application techniques that introduce surface tensions at different levels on the opposite top and bottom side of the flattened connector shapes 100. The deformation fronts DF1, DF2 are thin, linear areas along which a change in the sheet metal structure is induced preferably substantially homogeneous but at least symmetrical in direction along the deformation fronts DF1, DF2 within the lateral boundaries of the shapes 100. Symmetrical structure modification may be along the deformation fronts DF1, DF2 may be induced for example with a combined cutting and rolling operation during which an angled contour stamp progressively cuts out the shapes 100 as is well known in the field of sheet metal cutting. The cutting stamp may be angled such that the cut progresses in conjunction with the deformation fronts DF1, DF2.

During fabrication, the deformation fronts DF1, DF2 may continuously progress as may be the case during rolling and progressive cutting or may be implemented in repetitive steps as for example during laser scribing. The orientation of the deformation fronts DF1, DF2 defines the orientation of the first and second long sides. A deformation front DF1 parallel to the coiling axis CA results in long sides substantially parallel to the coiling axis CA. A deformation front DF2 non parallel to the coiling axis CA may result in conical coils with long sides in an angle to the coiling axis CA as may be well appreciated by anyone skilled in the art. Deformation fronts DF1, DF2 may be defined in context with the sheet metals deformation properties and the final coiling configuration of the connector 10 as may be well appreciated by anyone skilled in the art.

The differentiated opposite surface treatment may also be induced prior to shaping of the flattened connector shapes 100. For example, a sheet metal stripe of continuous width may be rolled up to a spiral in correspondence to the final connector 10. The sheet metal may be of a resilience such that the up rolled stripe may be stretched out and adhered to a planar substrate without loosing its previously induced spiral shape. After cutting out the shapes 100, the work piece may be released from its substrate allowing it to roll up again into its previously induced coiled condition.

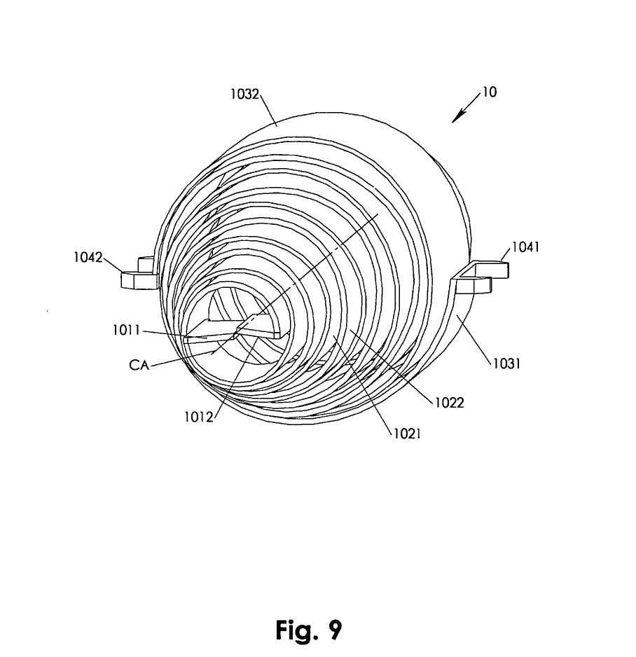

Referring to FIG. 9, a connector 10 may be composed of two or more sheet metal structures intertwined around the coiling axis CA. Each of the independent structures has interlocking structures 1041, 1042, a base arc 1031, 1032, spring bands 1021, 1022 and contacting tips 1011 and 1012. The contacting tips 1011, 1012 may be configured as edges in a cone angle to the coiling axis CA providing a self centering on a spherical test contact as may be well appreciated by anyone skilled in the art.

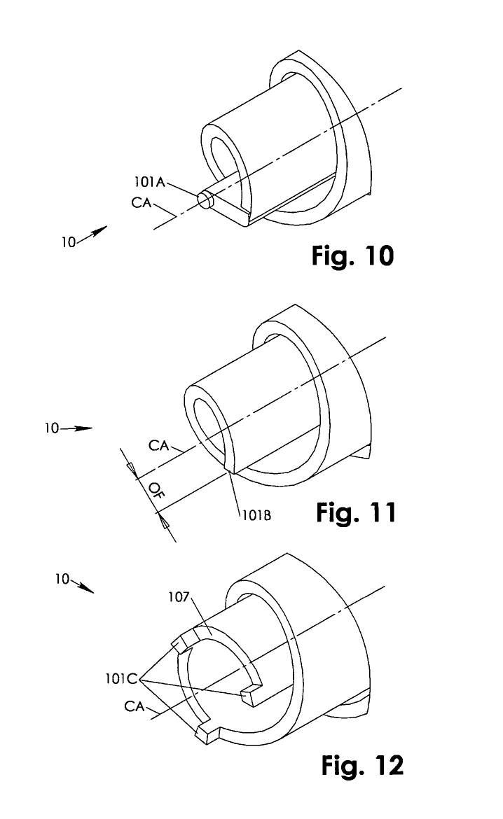

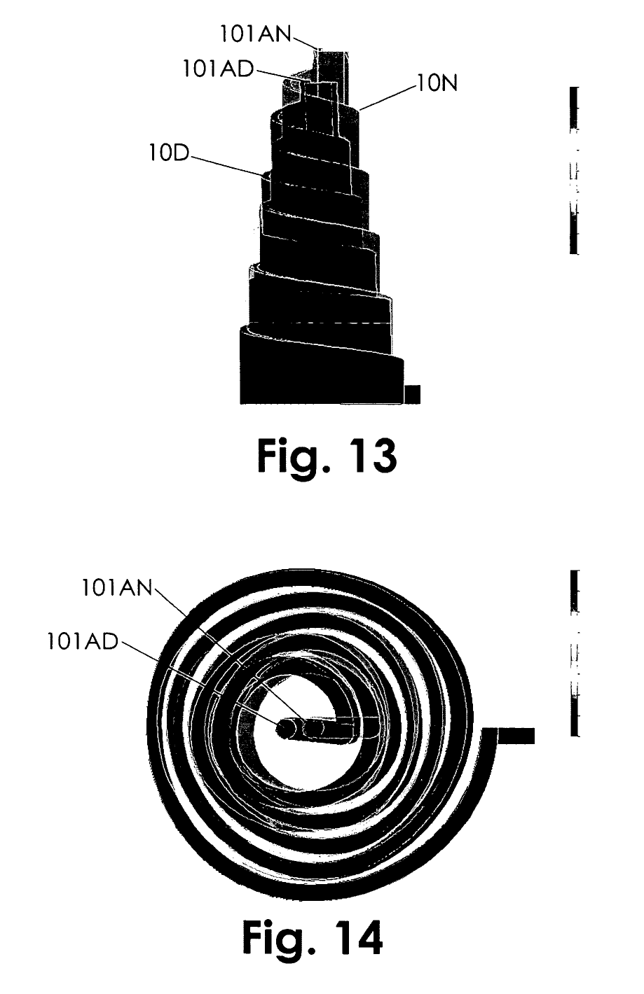

Scrubbing action during test contacting is influenced by the configuration of the contacting tips 101A, 101B, 101C. For a contacting tip 101A as in FIG. 10, which is substantially centered with respect to the coiling axis CA, lateral forces may be neglect able in a first contacting condition with a contacting force applied on the contacting tip 101A in direction axially along the coiling axis CA and a test contact substantially perpendicular to the coiling axis CA at least at the interface between the centered connecting tip 101A and the test contact. The spectral displacement plots of FIGS. 13 and 14 depict the resulting spatial displacement for a given exemplary configuration of a sheet metal coil spring connector 10 and for a given contacting force axially along the coiling axis CA. The scale in the FIGS. 13-17 illustrate the spectral colors associated with a proportional displacement wherein dark blue represents zero displacement and wherein dark red represents maximum spatial displacement. Also in the FIGS. 13-17, a natural non deflected connector 10N is transparently superimposed in grey onto the same but deflected connector 10D plotted in spectral colors. The plots are computer generated with a commercially available finite element analysis software.

The deflected centered contacting tip 101AD is displaced relative to the natural centered contacting tip 110AN mainly in direction axially along the coiling axis CA. A marginal off axis displacement may be contributed to the way the two coils 102 are approaching the base arc 103 creating a wedge allowing for local deflection. See FIG. 5 where the wedge is visible. Also, a bridge 105 may radially connect the centerend contacting tip 101 with the coils 102 introducing a certain torque on the coil 102 close to the tip. The bridge 105 may be needed for fabrication purposes since the minimum coiling radius has to be greater than zero. For example, a connector 10 made of Stainless Steel with a thickness of about 25_m with 5 coils with an average second long side of about 0.3 mm, a base arc 103 outside diameter of 0.5 mm, an overall height between opposing contacting tips 101A of 2.5 mm, is estimated to resiliently deflect up to 0.8 mm, under a maximum spring force of about 30 grams.

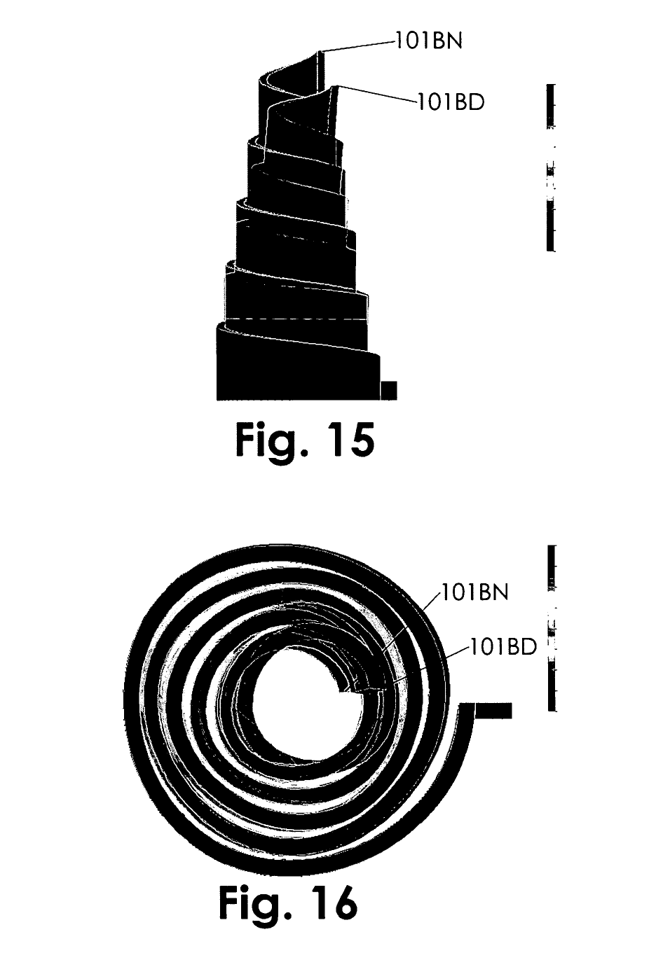

A contacting tip 101B of FIG. 11 with the contacting tip 101B in a substantial offset OF to the coiling axis CA a radial displacement component may be defined in combination with deflection in direction axially along the coiling axis CA. This is illustrated in the spectral displacement plots of FIGS. 15 and 16. The radial displacement component may be utilized for a radial scrubbing action along the surface of the test contact as may be well appreciated by anyone skilled in the art.

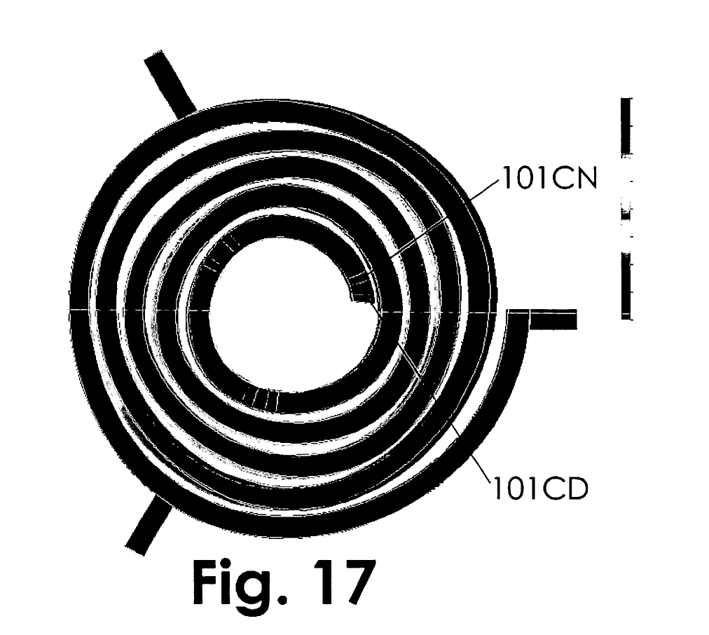

A contacting tip 101C of FIG. 12 with multiple contacting tips 101C circumferentially arrayed with respect to the coiling axis CA may contact a test contact in a second contacting condition in which the scrubbing action results mainly from an angular displacement of the contacting tips 101C around the coiling axis CA. In a special case, the contacting tips 101C may be circumferentially arrayed in conjunction with a spherical shape of the test contact such that the second contacting condition includes a self centering of the contacting tips 101C with respect to the spherical test contact. The top spectral displacement plot of FIG. 17 illustrates such case.

Referring back to FIGS. 6 and 7, the coil bands 102 may be tapered with its second long side reducing away from the base arc 103 for a balanced maximum stress and consequently maximum deflection. A certain minimal second long side has to remain at the contacting tip 101A, 101B, 101C for their structural support as may be well appreciated by anyone skilled in the art. A pitch of the coils may be adjusted to the reducing second long side such that all coils overlap at least under operational deflection. In case of a substantially equal orientation of the second long sides of each coil with respect to the coiling axis CA, the flattened coiling bands 102 may be curved towards parallel in direction away from the flattened base arc 103.

Accordingly, the scope of the invention described in the specification above is set forth by the following claims and their legal equivalent:

1. A sheet metal coil spring connector comprising:
a. a radially resilient base arc substantially concentric with respect to a coiling axis;
b. a spring band extending from said base arc, said spring band radially and axially coiling with respect to said coiling axis such that at least two adjacent coils of said spring band overlap in axial direction with respect to said coiling axis and radially support each other at least in operationally deflected condition; and
c. a contacting tip at a peripheral end of said spring band.

2. The connector of claim 1, wherein said radially support provides a shortcutting conductive contacting across said adjacent coils in direction about parallel to said coiling axis.

3. The connector of claim 1, wherein said base arc has a first lengthy cross section with a first long side being substantially parallel to said coiling axis.

4. The connector of claim 1, wherein two of said at least two adjacent coils have a second lengthy cross section.

5. The connector of claim 4, wherein a second long side of said second lengthy cross sections are substantially parallel to said coiling axis.

6. The connector of claim 4, wherein a second long side of said second lengthy cross section is in a positive angle to said coiling axis providing for a circumferential and conical interlocking of adjacent loops during said operational deflection.

7. The connector of claim 1, further comprising an interlocking structure radially protruding from said base arc.

8. The connector of claim 1, comprising two representations of said spring band extending from said base arc in opposite direction substantially along said coiling axis.

9. The connector of claim 1, held with said base arc in a correspondingly shaped fit of a base plate.

10. The connector of claim 9, further comprising an interlocking structure radially protruding from said base arc, said interlocking structure interlocking with a recess feature of said fit.

11. The connector of claim 9, comprising two representations of said spring band extending from said base arc in opposite direction substantially along said coiling axis and wherein said fit is a through hole holding said connector such that said two representation extend from opposites sides of said base plate.

12. The connector of claim 9, wherein said base arc is conductively connected to a conductive lead of said base plate.

13. The connector of claim 1, wherein said contacting tip is substantially centered on said coiling axis.

14. The connector of claim 1, wherein said contacting tip is in a substantial tip offset to said coiling axis.

15. The connector of claim 1 being part of a probe apparatus for testing electronic circuitry.

16. The connector of claim 15, wherein said probe apparatus provides a contacting movement of said connector that is substantially parallel to said coiling axis.

17. The connector of claim 15, wherein said probe apparatus provides a first contacting condition between said contacting tip and a tested contact such that said contacting tip provides a second scrubbing action along said tested contact, said first scrubbing action being substantially radial with respect to said coiling axis.

18. The connector of claim 1, wherein at a top edge of said spring band multiple representations of said contacting tip are arrayed substantially concentric with respect to said coiling axis.

19. The connector of claim 18 being part of a probe apparatus for testing electronic circuitry, said probe apparatus providing a second contacting condition between said contacting tip and a test contact such that said multiple representations of said contacting tip provide a second scrubbing action along said test contact, said second scrubbing action being substantially circumferential with respect to said coiling axis.

20. The connector of claim 19, wherein said test contact is spherical and wherein said multiple contacting tips are arrayed to provide a self centering with respect to said spherical test contact.

21. The connector of claim 1, wherein two or more representations of said connector are intertwined around said coiling axis.

22. The connector of claim 1, wherein multiple representations of said connector are combined on a single base plate.

23. The connector of claim 1, wherein the second length reduces in direction away from said base arc.

24. The connector of claim 23, wherein a pitch between adjacent coils reduces in direction away from said base arc.

25. The connector of claim 24, wherein said coil band is tapered and curved in flattened condition.
